(19) United States
(12) Patent Application Publication
(10) Pub. No.: US 2007/0058890 A1
(43) Pub. Date: Mar. 15, 2007

(54) Novel foil bearing

(76) Inventor: Farid Al-Bender, Kessel-Lo (BE)

Correspondence Address: BACON & THOMAS, PLLC, 625 SLATERS LANE, FOURTH FLOOR, ALEXANDRIA, VA, 22314, US

(21) Appl. No.: 10/565,937

(22) PCT Filed: Jul. 29, 2004
(86) PCT No.: PCT/BE04/00109

§ 371 Date: Jan. 26, 2006

(30) Foreign Application Priority Data
Jul. 29, 2003 (GB) 0317722.7

(51) Int. Cl. F16C 32/06

(52) U.S. Cl. 384/104

(57) ABSTRACT

The present invention relates to a new kind of foil bearing. The present invention relates to a bearing comprising a flexible foil with a self-aligning mechanism. The present invention furthermore relates to a foil bearing enabling a linear and/or rotary movement along/around an axis (i.e. a shaft). The present invention also relates to a foil gas/air bearing with a self-aligning mechanism. The present invention furthermore relates to the use of said foil bearing in machines, more specifically in precision and/or high-speed machines and in high-speed precision spindles.

### FIELD OF THE INVENTION

The present invention relates to a new kind of foil bearing. The present invention relates to a bearing comprising a flexible foil and a self-aligning mechanism. The present invention furthermore relates to a foil bearing enabling a linear and/or rotary movement along/around an axis (i.e. a shaft). The present invention also relates to a foil gas/air bearing with a self-aligning mechanism. The present invention furthermore relates to the use of said foil bearing in machines, more specifically in precision and/or high-speed machines and in high-speed precision spindles.

### BACKGROUND OF THE INVENTION

Semiconductor fabrication, high-resolution scanning, and high-speed machinery are just some of the applications pushing (rolling-element) bearings to technical limits. One reason for this is friction and variations therein, which have always posed problems for precision positioning systems. More force is needed to initiate motion than to maintain it, leading to an imbalance between start and stop and leading to a stick-slip action. This problem is higher for plain bearings than for rolling bearings, because of differences in static and dynamic friction coefficients.

An option to circumvent the friction problem is the use of fluid, liquid or air bearings, in which solid-solid contact is eliminated. Fluid, i.e. hydrodynamic, hydrostatic, aerodynamic or aerostatic bearings eliminate the stick-slip problem, because static friction is zero, making infinite-motion resolution theoretically possible and reducing the power loss. Most large turbines today use oil-based hydrodynamic bearings, though many new microturbines employ aerodynamic bearings to improve efficiency.

Besides smoothing stop and starts, air bearings offer less resistance (friction) to steady-state motion. Friction generates heat which, in turn, causes spindles and other components to thermally grow, compromising precision. Fluid bearings, in particular, air bearings generate much less heat in a given application than rolling-element or plain bearings in most cases. In fact, relative speeds must exceed about 100 ft/sec (30 m/s) before air bearings generate any significant heat at normal air gaps. Air bearings excel in applications requiring tight velocity control such as scanning and wafer inspection, because they eliminate force ripples from recirculating ball bearings loading and unloading.

Air bearings have been operated in process fluids other than air, such as helium, xenon, air-conditioner refrigerants, liquid oxygen, and liquid nitrogen. For applications in vapor cycles, the refrigerant can be used to cool and support the air bearings without the need for oil lubricants that can contaminate the system and reduce efficiency.

The trend to make machines faster and more precise leads to an increasing demand for gas or more specifically air bearings. Air bearings are however expensive and delicate. A cheap solution of an air bearing with high performance and accuracy is problematic, especially in case of bearing around a shaft. Furthermore, traditional air bearings for axial movement have a rigid form. The special geometry of the gap between shaft and bearing surface is difficult to create and is only ideal under certain conditions.

An attempt to overcome some of the problems has been undertaken by using air bearings made with, for example, orifice or with porous technology, in order to achieve a more uniform pressure distribution. Orifice compensation distributes pressurised air across a bearing face through strategically placed, precisely sized orifices and grooves. But scratches across a groove or near orifices may cause more air to escape than orifices can supply, causing a bearing to crash at normal air-supply pressures.

In general, air bearings with hard bearing surfaces are still showing problems with reliability. For example, since the running radial clearance between the shaft and a bearing is very small (usually less than 0.0005 inch (7.5 micron) for a 2-inch (50 mm) diameter shaft at 36,000 rpm), shaft growth caused by temperature and centrifugal force can be problematic. In addition, damping is required to suppress any whirl instability, and there can be misalignment between various rotating parts and stationary parts.

In the prior art, this problem is solved by foil bearings. While the shaft is stationary, there is a small amount of preload between the shaft and the bearing. As the shaft turns, hydrodynamic pressure is generated, pushing the foils away from the shaft and making the shaft completely airborne. This phenomenon occurs instantly during start-up at a very low speed. When the shaft is airborne, the friction loss due to shaft rotation is quite small. As the shaft grows, the foils get pushed further away, keeping the film clearance relatively constant. In addition, the foils provide coulomb damping due to their relative sliding. This damping is essential for the stability of the machine.

Currently, foil bearings are limited to rotational axes and most of the time they are working without air supply (aerodynamic), which limits their stiffness considerably: indeed, the stiffness achieved by self-acting foil bearings is negligibly small. Furthermore, in current foil bearings, the foil does not envelop the axis in a perfect way, leading to air lost and a reduction of the capacity or a malfunction of the bearing.

U.S. Pat. No. 4,251,119 describes a gas foil bearing for textile machines comprising a foil, means for fixedly supporting the foil and means for fixedly securing the foil, so configured that the foil has a predetermined curvature substantially corresponding to the radius of curvature of the rotatable member (rotor shaft). Furthermore, also a movable hose attached to the foil in order to create a gas film is described. This foil bearing has however also the disadvantage that because the foil is fixedly supported to have a predetermined curvature corresponding to the radius of the rotor shaft, the foil will not envelop the shaft/axis in a perfect way during the process (e.g. misalignment resulting from thermal expansion, relative motion between bearing and shaft, vibrations, etc), leading to air lost and a reduction of the capacity or a malfunction of the bearing.

As a summary, there is still a need for foil (fluid/gas/air) bearings with a high performance and accuracy and with different and multiple movement possibilities around an axis (rotary and linear movement). Therefore, a goal of the present invention is to satisfy this need by creating a new foil air bearing enabling a linear and rotary movement along/around an axis (i.e. shaft) with a high performance, in regard to load capacity, stiffness and damping, and with a self-aligning mechanism.

### SUMMARY OF THE INVENTION

In the present invention, a new foil bearing is being provided. The present invention provides new foil bearings, in a particular embodiment fluid or more specifically gas foil bearings and deals with their use. The new foil bearings can be used in machines, more specifically in precision and/or high-speed machines and in high-speed precision spindles.

The present invention relates to a new kind of bearing. The present invention relates to a foil bearing comprising a flexible foil and a rigid frame or base structure. More in particular, the present invention relates to a foil bearing enabling a linear and/or rotary movement along/around an axis (i.e. a shaft). The present invention furthermore relates to a new foil bearing in which the foil envelops the axis perfectly during operation. This perfect fitting of the foil is obtained due to the provision of a self-aligning mechanism, more in particular through the provision of means for supporting and/or positioning the foil, such means allowing self-alignment (i.e. because of a kinematic support). The self-aligning mechanism allows the foil to adapt itself during the process to envelop the shaft/axis in an optimal way. The present invention relates to a foil bearing with a self-aligning mechanism, thus relates to a foil bearing comprising a rigid frame, at least one flexible foil and a self-aligning mechanism. In another embodiment, the present invention relates to a new foil bearing with a self-aligning mechanism comprising a rigid frame, at least one flexible foil and supporting and/or positioning means.

The present invention relates to a foil bearing with a self-aligning mechanism, comprising a foil, wherein the foil can be made of metal, plastic or any other convenient material. The foil(s) is extended between a first and a second attachment point on the frame. These attachment points can be outside or inside of the frame. In a more particular embodiment, at least one attachment point is on the outside of the frame. The foil can be attached or fixed to the frame by clamping members, by welding or by gluing.

In yet another embodiment, the foil bearing comprises multiple foils or at least one or more than one foil, wherein multiple foils are attached to the frame, in a particular embodiment through clamping means, yet in another particular embodiment with one end of each foil attached at the outside of the frame and the other end attached at the inside of the frame. In yet another particular embodiment, the foils are cutting each other or are woven into each other, in order to allow optimal contact between the foils and the shaft. The present invention therefore also relates to a foil bearing, comprising two different foils within one frame. Another yet more particular embodiment of the present invention relates to a foil bearing with a self aligning mechanism, comprising two foils, wherein one end of the first foil is attached to the outside of one end of the frame, the other end of the first foil is attached to the inner side of the frame, more in particular at the top of the frame, while one end of the second foil is attached at the opposite outside part of the frame and the other end of the second foil is attached at the inner side of the frame, more in particular at the top of the frame.

The present invention relates to a new foil bearing for linear and/or rotary movement along/around an axis. In a particular embodiment, the present invention relates to a new foil bearing with a self-aligning mechanism, comprising supporting and positioning means, attached to the frame, which allow the foil to adapt its position during the process in order to envelop the shaft/axis in an optimal way. In a particular embodiment, the self-aligning mechanism comprises a kinematic support arrangement, wherein in a particular embodiment, the supporting and positioning means have a kinematic support arrangement, with in yet another more particular embodiment with 2×3 degrees of freedom. In a particular embodiment, the supporting and positioning means have the freedom to rotate or move (i.e. about their support point) in order to align the foil in an optimal way. In a particular embodiment, there can be 1, 2, 3, 4 or more supporting and positioning means.

The supporting and positioning means can have any form suitable for its function. In a particular embodiment, the supporting and positioning means is cylindrical. In order to have the self-aligning system, the cylinder can be attached to the frame in a suitable way allowing the rotation of each cylinder about the two axes normal to its geometrical axis. In yet a more particular embodiment, the present invention relates to a new foil bearing comprising a foil extended between a first and a second attachment point on a frame and a means for supporting and positioning the foil, more in particular via the use of at least one cylinder, such cylinder supported or attached in such a way as to have the freedom to rotate about its support point. In a particular embodiment of the present invention, the foil bearing comprises at least two cylinders or comprises more than 2 cylinders, such as 3 or 4. In a particular embodiment of the present invention, at least one of the cylinders is self-aligning, yet more in particular, two cylinders are self-aligning. In yet another more particular embodiment, the foil bearing comprises two self-aligning cylinders, whereby the foil embraces the round rails of the cylinders. The present invention relates thus in a particular embodiment to a new foil bearing with at least one flexible foil, a frame and a self-aligning mechanism, said self-aligning system comprising (at least) two cylinders attached (to the frame) in such a way that the rotation of each cylinder about the two axes normal to its geometrical axis is possible. A particular embodiment relates to a novel foil bearing with a self-alignment system comprising cylindrical supporting and positioning means which are attached to the frame through small pins forming point contacts in blind holes drilled in the cylindrical supporting and positioning means. In another particular embodiment, the self-aligning system is obtained through the use of a spring or multiple springs, which are in a particular embodiment attached to the frame. The supporting and positioning means can comprise in a particular embodiment a spring.

Therefore, the present invention relates in a certain embodiment to a foil bearing with a flexible foil, a frame, a supporting and positioning means which is cylindrical which can rotate about the two axes normal to its geometrical axis, thereby establishing a self-aligning mechanism.

The present invention relates to a novel foil bearing with or without an external fluid supply. Therefore, a particular embodiment of the present invention relates to a new foil bearing which is externally provided with a fluid or externally pressurised, so that a fluid (gas or liquid) foil bearing is obtained. The fluid can be a gas or a liquid (i.e. oil), while the gas can be air or other gases as known in the art, such as xenon, helium, etc. The fluid or gas can be supplied through the foil or through the shaft. In a particular embodiment, the invention relates to an externally pressurised gas foil bearing wherein the gas is supplied through at least one gas supply, which can be a hose attached to the foil or to the shaft. In a particular embodiment, multiple gas supplies are provided which deliver gas through the foil or through the shaft or a combination of both. Therefore, the present invention also relates to a gas foil bearing with multiple or more than one gas supply, which can be 2, 3, 4 or more. The gas supplies can be flexible or rigid. In a particular embodiment, the invention relates to a gas foil bearing with a self-aligning mechanism and which comprises at least one flexible gas supply, yet in a more particular embodiment, the gas supply is delivered through the shaft. In a particular embodiment, the gas supply can be rigid or not flexible and could also be used to fix the foil to the frame. In yet another particular embodiment of the present invention, the flexible supply is made of plastic, rubber or any other convenient material. In another embodiment of the present invention, the air of the foil air bearing is supplied via the shaft.

In any of the previously mentioned embodiments, the empty space between the foil and the rigid frame may be filled with flexible material, such as a flexible sponge, foam or rubber material, which adheres to the foil and housing (frame) and serves to hold the foil approximately in concave form to facilitate for example storage and assembly.

Thus, one embodiment of the present invention provides an externally pressurised foil bearing for linear and/or rotary movement along/around an axis, compromising a foil extending between a first and a second attachment point, a flexible fluid supply and two cylinders supporting and positioning the foil. More particularly, the present invention relates to an externally pressurised foil bearing for linear and/or rotary movement along/around an axis with a self-aligning mechanism, comprising a foil extending between a first and a second clamping member, a flexible gas supply and a means for supporting and positioning the foil.

The present invention furthermore relates to a foil bearing wherein two cylinders support and position the foil and are constructed to have a self-aligning mechanism, giving the foil the necessary degrees of freedom it needs to cover the axis/shaft appropriately and enlarging the contact area.

In another embodiment of the invention, the foil of the foil bearing is additionally fixed to the frame at the internal side, more in particular at or around the middle of the frame.

One particular embodiment of the present invention relates to a foil bearing with a foil or at least one foil, a frame, whereas the foil is attached to the frame, and at least one supporting and positioning means, characterised in that the supporting and positioning means allows for a self-aligning system, in a particular embodiment because the supporting or positioning means can rotate around two axes normal to its geometrical axis. In a particular embodiment, the supporting and positioning means is cylindrical or the supporting and positioning means is attached to the frame and thereby points out of the frame.

In a particular embodiment, the foil bearing of the present invention comprises a foil or multiple foils wherein said foil(s) has stiffening ribs or any other texture or cross-sectional profile, to enhance stiffness and/or damping.

Another more particular embodiment relates to a foil bearing with a self-aligning mechanism, comprising a foil which is supported by electromagnetic, magnetostrictive, piezoelectric or any suitable type of actuator, so that the foil could be moved statically or dynamically during operation, whereby its characteristics could be controlled.

Yet in another embodiment of the invention, the foil is made from a “smart” material, e.g. PVD or piezoelectric material, so that the characteristic of the foil could be changed during operation, by controlling an electric current that is fed to the foil.

An embodiment of the present invention relates to a foil bearing with at least one foil attached to a frame and at least one supporting and positioning means for the foil, characterised in that:
the foil is attached to the outside of the frame at two different attachment points at the opposite sides of the frame;
the supporting and positioning means allows for a self-aligning system and the foil embraces the supporting and positioning means and extends over the shaft; and
there is a flexible gas supply, in one embodiment attached to the foil, yet in another embodiment, attached to the shaft.

Another specific embodiment relates to a foil bearing with at least one foil attached to a frame and at least one supporting and positioning means for the foil, characterised in that:
there is only one foil attached to the outside of the frame at two different attachment points at the opposite sides of the frame;
there are two cylindrical supporting and positioning means attached at the opposite sides of the frame whereby the foil embraces the round rails of the two cylinders and extends over the shaft, whereby in a particular embodiment, the cylinders can rotate around two axes normal to its geometrical axis, allowing for a self-aligning system; and
there is a flexible gas supply, in one embodiment attached to the foil, yet in another embodiment, attached to the shaft.

Yet another specific embodiment relates to the foil bearing as described herein, characterised in that the foil is additionally fixed to the middle of the frame. The fixation of the foil in the middle of the frame at the internal side can be achieved through clamping means or gluing or welding and in a particular embodiment, the additional fixation point could also allow the supply of gas or liquid through this fixation point. In yet another particular embodiment, two gas supplies are attached to the foil, one at each side of the fixation point in the middle of the frame.

Yet another more particular embodiment relates to a foil bearing with a foil attached to a frame and a supporting and positioning means for the foil, characterised in that:
there are two foils each of them attached with one end to the outside of the frame and the other end attached to the inside of the frame, whereby the foils are interwoven or are cutting each other;
there are two cylindrical supporting and positioning means attached at the opposite sides of the frame whereby each foil embraces one cylinder and extends over a part of the shaft, whereby in a particular embodiment, the cylinders can rotate around two axes normal to its geometrical axis, allowing for a self-aligning system; and
there are two flexible gas supplies, in one embodiment attached to the foil, yet in another embodiment, attached to the shaft, one for each foil.

In yet another specific embodiment, the invention relates to the foil bearing as described herein, characterised in that there are two additional (cylindrical) supporting and positioning means attached directly or indirectly to the frame (i.e. to an additional plate attached to the frame) so that in total four cylindrical supporting and positioning means attached to the frame or to an additional base plate attached to the frame are present whereby each of them could allow and at least one allows a self-aligning mechanism. In a particular embodiment, the foil is additionally fixed to the frame. In yet another particular embodiment, the two extra cylindrical supporting and positioning means are attached in such a way that they support and position the foil around the middle of the foil, in a particular embodiment next to the additional fixation point of the foil to the frame.

Another aspect of the invention relates to the use of said novel foil bearing in machines, more specifically in precision and/or high-speed machines and in high-speed precision spindels. The invention furthermore provides a new kind of air bearing for precise and/or rapidly moving parts along or around a shaft. The new foil bearings can be used in slideways for precision machine tools, precise measuring machines, high-speed machinery and test equipment. High-speed precision spindles for turning, milling or grinding are other applications the foil bearing could be used for.

### BRIEF DESCRIPTION OF THE FIGURES

FIG. 1 is a lateral view of the standard embodiment of the air bearing.

FIG. 2 is a longitudinal cross-sectional view of this embodiment taken along line II-II.

FIG. 3 is a longitudinal cross-sectional view of an embodiment with fluid supplied through the shaft.

FIG. 4 is a lateral view of an embodiment of the air bearing with multi-directional stiffness only using a fixation.

FIG. 5 is a longitudinal cross-sectional view of the embodiment in FIG. 4 along line V-V.

FIG. 6 is a lateral cross-sectional view of the embodiment of FIG. 7 along the line VI-VI. It is an air bearing with multi-directional stiffness using additional positioning parts.

FIG. 7 is a longitudinal cross-sectional view of the embodiment of FIG. 6 taken along the VII-VII.

FIG. 8 is a lateral view of an embodiment of the air bearing with multi-directional stiffness using two separate foils cutting each other.

FIG. 9 is a longitudinal cross-sectional view of the embodiment of FIG. 8 along the line IX-IX.

FIG. 10 is an illustration of a possible configuration of the two cutting foils.

FIG. 11: Foil bearing prototype of an embodiment of the present invention.

FIG. 12: Test system to investigate the behaviour of aerostatic foils.

FIG. 13: Graphical representation of the theoretical and experimental results obtained with the foil bearing prototype.

### DETAILED DESCRIPTION OF THE INVENTION

Definitions

“Flexible supply” as used herein shall mean that the means for supply shall be bendable, in a particular embodiment for more than 1°, more in particular more than 5° and yet more in particular more than 20° and yet more in particular more than 45°, under standard conditions. “Foil” shall mean any (thin) plate of material that is flexible in bending so that it can be folded around a shaft, cylinder, or rotatable member.

With “self-aligning mechanism” or “self-aligning system” is meant a mechanism allowing the self-adaptation of the position or alignment of the foil, in order to envelop the shaft/axis in an optimal way (and this without intervention from the outside).

Description

Application of conventional rigid radial aerostatic bearings has two main drawbacks: a technical one and an economic one, which are interconnected. The technical drawback lies in the inherent problem of “conformity” between shaft and bearing (bush). In contrast to flat bearings, where the gap does not change in character (i.e. convex, concave or parallel) with the relative normal displacement of bearing to platen, the gap between a shaft and a bush will change from convex, through parallel to concave, with the relative eccentricity. This is a geometry existing in presently available bearings. The economic or cost side lies in the fact that radial bearings, both of the full and partial type, are very costly to produce owing to the close tolerances that have to be observed. As an example, bearing bushes have to be produced for an “exact” given size of shaft, which makes their interchangeability well-nigh impossible.

With our invention, a low-cost (fluid) bearing type that can overcome both hereinabove outlined problems simultaneously has been developed. The present invention provides a novel foil bearing with a self-aligning mechanism. The foil bearing comprises a mechanism allowing the self-adaptation of the position or alignment of the foil, in order to envelop the shaft/axis in an optimal way (and this without intervention from the outside).

Research in foil bearings dates back to many decades ago, the greatest effort being devoted to self-acting (aerodynamic) bearings. Two basic categories were considered: (i) moving-web type bearings, including tape-recording applications [1], with which there has been little preoccupation since then, and (ii) leaf and bump type [2], which continues to evolve till now, with important applications in the aviation and general high speed rotor systems. This type of bearings can achieve very high load capacity, however with very low stiffness. The foil bearing type described in this patent is an (externally pressurised) development of the first category above. It has the advantage of compliant surface, possibly combined with the high stiffness obtainable from external pressurisation. Possible applications of the new foil bearings are linear slideway systems, e.g. for high speed pick-and-place machines, where they could form a viable alternative to conventional precision bearing types, but also to a variety of radial and axial bearing applications where the loads are high, stiffness requirements medium and friction low.

The present invention provides a new kind of bearing, more specifically (fluid) foil bearing, for precise and/or rapidly moving parts along or around a shaft wherein the bearing has the advantage of lower cost along with minimal requirements on the shaft's surface. In particular, one and the same foil bearing unit (frame and foil) can be used on a range of shaft sizes, since the foil, unlike a rigid bearing, can adapt itself to fit the new size of shaft. The bearing can also be used in precise and high-speed spindles.

Traditional flat gap air bearings have start-up problems, as the air pressure will only push on the surface beneath the supply hole. Temporary lift of the load is needed for operation. Our foil bearing however does not have this problem because the supply pressure will lift the foil locally. This increases the surface on which the pressure is pushing and the foil will gradually rise until a continuous air gap is built up in the whole bearing.

For good working conditions it is preferred that the foil envelops the axis perfectly during operation. If not, air will be lost and the loading capacity of the bearing will be reduced or the bearing will malfunction. To avoid aligning problems when using foil bearings a mechanism of supporting and positioning means, in a particular embodiment comprising two cylinders, has been developed that enables fixation of the foil and provides sufficient degrees of freedom for the foil to surround the axis. The supporting means, e.g. small cylinders, support the foil and position it in a good way, while giving it the possibility to move and thereby allows an optimal positioning of the foil during movement.

Stiffness in different radial directions is achieved by placing several foil bearings relatively rotated with respect to each other or by integrating two bearings in one frame.

U.S. Pat. No. 4,251,119 describes a gas foil bearing for textile machines comprising a foil, means for fixedly supporting the foil and means for fixedly securing the foil, so configured that the foil has a predetermined curvature substantially corresponding to the radius of curvature of the rotatable member (rotor shaft). Furthermore, also a movable hose attached to the foil in order to create a gas film is described. This foil bearings has however the disadvantage that because the foil is fixedly supported to have a predetermined curvature corresponding to the radius of the rotor shaft, the foil can not envelop the shaft/axis in a perfectly and can not adapt itself to envelop the shaft/axis in a perfect way, for example when needed owing to misalignment of the foil or of its supporting frame or means, or when changing to a different shaft diameter, which leads to air lost and a reduction of the capacity or a malfunction of the bearing. The position of the foil in U.S. Pat. No. 4,251,119 will not be self-adapting during changes in the process (e.g. misalignment resulting from thermal expansion, relative motion between bearing and shaft, vibrations, etc.). This self-adaptation is necessary because as stated before, with the relative normal displacement of bearing to shaft the gap between a shaft and foil will change from convex, through parallel to concave, with the relative eccentricity.

Thus, in the present invention, a type of foil (fluid/gas/air) bearings has been developed which delivers a better positioning of the foil to the shaft and even during rotation, the foil can be adapted to embrace the shaft in a better way by a self-aligning mechanism. The foil bearing can also be externally pressurised. The foil bearing of the invention comprises cylindrical supporting and positioning means which can be movable in two directions due to specific construction, allowing the better positioning of the foil. The foil bearing enables a linear or rotary movement along/around an axis (i.e. a shaft) with very low friction. It is very suited for precise positioning tools and high-speed machines.

The foil bearing of the present invention comprises a foil, a frame and a self-aligning mechanism, in particular obtained through movable supporting and positioning means. The frame can be of any arbitrary form allowing the functionality of the foil bearing of the invention. In a particular prototype, the frame is U-shaped.

The foil can be of different thickness, but has to be flexible. It can be made of metal, plastic or any other material which is suited for this purpose. The foil is attached to the frame at different attachment points and can be attached through different means. Also foil bearings comprising multiple foils are provided. The construction is made in this way so that each foil embraces the shaft on a different side. The foils are therefore interwoven. The invention is based on the use of a flexible foil instead of a hard bearing surface. The air spreads through the gap between axis and foil thereby lifting the load. If the air is supplied through the foil, the hose must be sufficiently flexible not to affect the shape of the air gap.

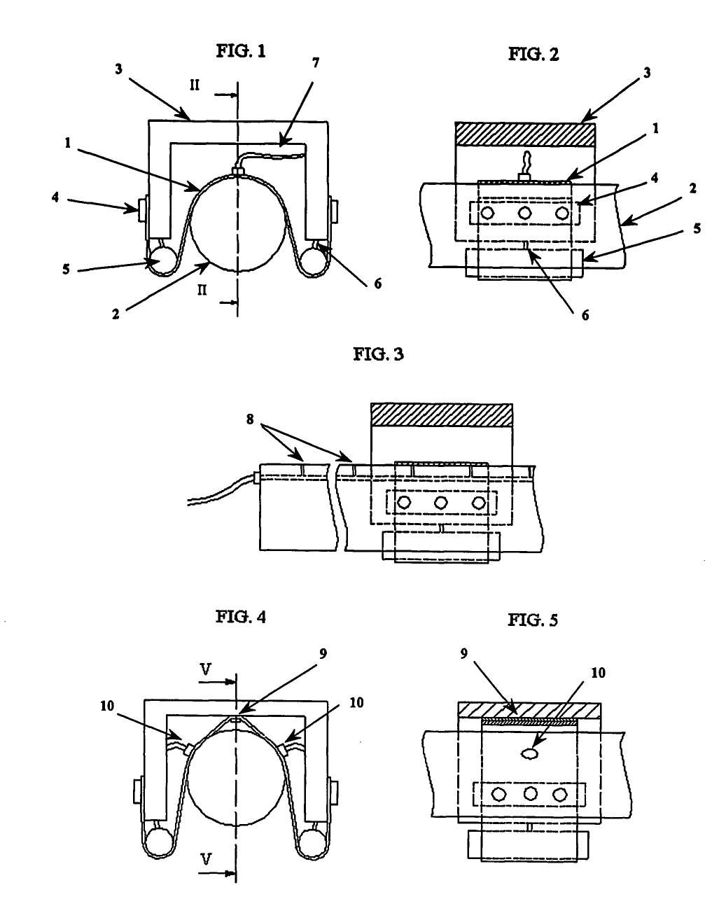

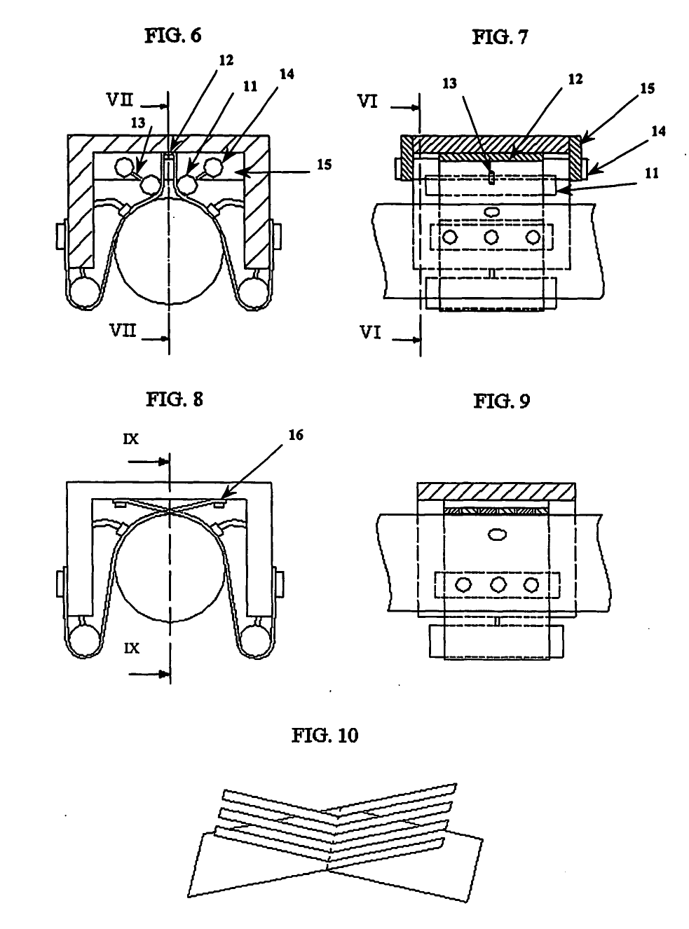

The supporting and positioning means are present in order to position the foil. In a particular prototype, these means for supporting and positioning the foil allow for the self-aligning mechanism. This can be obtained through any kinematic support arrangement, so that the foil's flexibility and its kinematic support allow an optimal air-gap geometry at all times. The kinematic support comprises supporting and positioning means which have the freedom to rotate or move (i.e. about their support point) in order to align the foil in an optimal way. The supporting and positioning means have to be constructed in such a way to allow for this rotation or movement. For example they can be movable around their attachment or support point. There can be one, two or multiple (3, 4, 5, 6, etc.) means for supporting and positioning the foil, like in a specific example there are 4 such supporting and positioning means. In FIG. 1 for example, there are two means ensuring the support and position of the foil (designated with no. 5), while in FIG. 6 the foil bearing comprises at least an extra two of such means (designated with no. 11).

In a particular prototype, the supporting and positioning means are cylindrical, but can have any form suitable for their function. Cylinders deliver a good positioning and support, due to a good contact with the foil, which embraces the round rail partially. The cylinders are movable in two directions so that an adaptation of the foil position and support is possible when necessary during the process. To obtain the freedom to rotate for the cylinders, the cylinders can be attached to the frame through small pins forming point contacts in blind holes drilled in the cylinders. The point contact connection between the frame and alignment cylinders does not impair the stiffness.

Another possibility for supporting and positioning means which would allow self-adaptation of the foil, would be the use of a spring or multiple springs. The spring can be attached to the shaft at one side and could support and position the foil at the other side. The spring will need to be flexible in order to allow the self-alignment system, but will also need to be stiff in order to deliver the right positioning and/or support for the foil. Also other possibilities exist in order to obtain the self-alignment system in the foil bearing. A combination of different mechanisms is furthermore also possible.

The invention relates mainly to externally pressurised fluid foil bearings. However, the self-aligning mechanism is also applicable for non-externally pressurised foil bearings. Fluid, i.e. hydrodynamic, hydrostatic, aerodynamic or aerostatic bearings eliminate the stick-slip problem. The fluid can be a liquid (i.e. oil) or a gas and can be other than air, such as helium, xenon, air-conditioner refrigerants, liquid oxygen, liquid nitrogen, etc. The fluid/gas supply can be obtained via the shaft or via the foil and multiple fluid supplies can be present. Also a combination of fluid supply through the shaft and the foil is possible. Supply through the shaft has the advantage that no fluid supply has to be attached to the foil, so that problems associated with this fluid supply through the foil, such as the movement of the supply during the process, are not encountered.

The present invention thus provides a foil bearing comprising a frame and a foil, characterised in that the foil bearing has a self-aligning mechanism which allows the foil to self-adapt its position. In a particular embodiment, the foil is attached to the frame and extended between a first and a second attachment point. The foil bearing further comprises in another embodiment a supporting and positioning means for optimally positioning and supporting the foil, wherein the supporting and positioning means allows for a self-aligning mechanism. Another embodiment relates to the foil bearing wherein the supporting and positioning means is cylindrical and can rotate around two axes normal to its geometrical axis. The foil bearing comprises in a particular embodiment two cylinders attached to the frame which can rotate around two axes normal to their geometrical axes. The cylindrical supporting and positioning means can be attached to the frame through small pins forming point contacts in blind holes drilled in the cylindrical supporting and positioning means. In another particular embodiment, the supporting and positioning means comprises a spring.

Another embodiment provides a foil bearing which is externally pressurised, more in particular through fluid supplied via the shaft or via the foil more in particular through one or multiple flexible fluid supplies, which in a particular embodiment are from rubber of plastic.

In another particular embodiment, two additional cylindrical supporting and positioning means are present. Also a second foil can be present, which more particularly is interwoven with the other foil.

### EXAMPLES

### Example 1

### Externally Pressurised Foil Bearing with One Air Supply Through the Foil and One Foil

A specific example of the foil bearing includes a rigid frame of any convenient shape (e.g. π), a flexible foil, a flexible gas/air supply line and two small self-aligning cylinders. The foil embraces the round rail partially. Liquid or gas is supplied via the flexible hose that is attached to the foil at one or several points. Small holes in the foil (the restrictors or supply holes) enable the fluid to enter the gap between shaft and foil. The thin foil is fixed to the frame by clamping plates, gluing, welding or any convenient way.

Two self-aligning cylinders guide and support the foil. They are attached to the frame by appropriate hinges. As these axes can rotate freely, for a certain amount, they make sure the foil is embracing the shaft correctly at all times, reducing alignment problems.

FIGS. 1 a and 1 b illustrate the embodiment of the present invention, which is suited for all applications. Multidirectional stiffness can be accomplished by placing several foil bearings relatively rotated to each other. A flexible foil 1 embraces the shaft 2 partially. The foil is made from a suitable material, metal, plastic, composite material, . . . , preferably with high bending flexibility and high tensile stiffness. The foil surface is required to be flat and smooth only on one side, namely the fluid film side or the side facing the shaft. (On the opposite side, it could be allowed to have “ribs”, or any other suitable profile, to increase tensile stiffness and/or to increase damping. The foil is fixed to a frame 3 by means of clamping plates 4, by welding or by gluing. The frame can be of any arbitrary form with the same functionality (e.g. n). To make sure the foil is surrounding the shaft appropriately a positioning system is added. Two small cylinders S support and guide the foil during operation. They are attached to the frame by suitable means allowing the rotation of each cylinder about the two axes normal to its geometrical axis. In this case, this is achieved by means of two small pins 6 forming point contacts in blind holes drilled in the cylinders.

A flexible hose 7 attached to the foil supplies the necessary fluid. For example pressured air is pressed between the foil and shaft thereby creating a small air gap enabling the relative displacement of bearing and shaft. Larger bearings may need several fluid inlets.

This foil bearing consists thus of a (thin) foil, which partially envelopes a shaft, while air is supplied through a flexible hose attached to the foil. The foil's flexibility and its kinematic support allow an optimal air-gap geometry at all times. Design theory has also been formulated in order to enable prediction of the characteristics and their optimisation. Tests on prototypes indicate that the foil bearing is far superior to conventional (rigid surface) bearings, in particular regarding load capacity and air consumption. Furthermore the production cost is much lower owing to simplicity of construction.

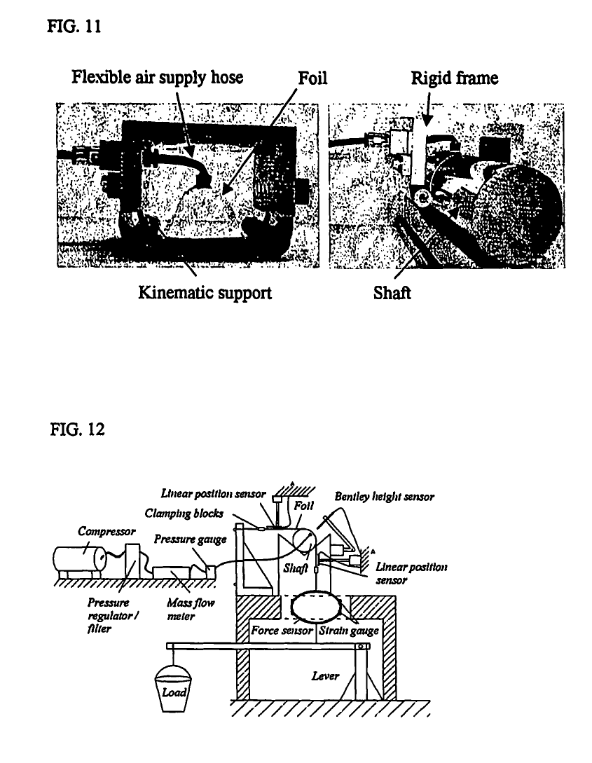

FIG. 11 shows a foil bearing prototype. The foil bearing consists of a thin metal foil, equipped with feeding hole(s), which enfolds the shaft (see FIG. 2). A flexible hose is attached to each feeding hole to supply pressurised air, in such a way as not to affect the foil shape. The foil is fixed to the rigid frame (body of the bearing) at both ends, passing over alignment cylinders Cinematic support system with 2×3 d.o.f.). In this way, the foil can wrap around the shaft correctly at all times. By virtue of its flexibility, the foil continuously adapts its geometry to different working conditions generating an optimal air gap. Furthermore such a bearing can accommodate a relatively wide range of shaft sizes without any alignment problem and is suitable for rotary as well as linear sliding applications.

The design parameters to be selected are: the supply air pressure, the foil geometry and material, the wrap angle, and the restrictor diameter(s) and location(s). Results show that very high load factors could be achieved; stiffness, however, is a major concern. The total stiffness of the bearing system can be represented as a serial connection of the air-gap stiffness and the foil stiffness. A “thick” foil results in a higher foil stiffness, but the load capacity may deteriorate owing to loss of wrap angle, and the air-gap stiffness may decrease owing to loss of flexibility of the foil. One measure to increase foil stiffness, without jeopardising load and film stiffness, is to minimise the total length of the foil.

### Example 2

FIG. 3 shows an implementation in which the air is supplied through the shaft. Several air inlets 8 in the shaft replace the need for a hose in the foil, thus overcoming the difficulty of air supply through the foil. This configuration can be useful for small stroke applications.

### Example 3

### Foil Bearing with an Extra Fixation of the Foil to the Frame

FIGS. 4 and 5 show a configuration enabling multidirectional stiffness in a single frame. This has the advantage of demanding less space than placing two separate bearings with stiffness in only one direction rotated with respect to each other. A negative aspect of this structure is the reduction in total stiffness. Fixation 9 of the foil in the middle of the frame results in two separately operating foil bearings rotated with respect to each other. Naturally, at least two supply holes are needed 10.

### Example 4

### Foil Bearing with Extra Cylindrical Supporting and Positioning Means and Extra Fixation to the Frame

FIGS. 6 and 7 illustrate an additional embodiment of the previous foil bearing. Two extra cylinders 11 ensure the proper placement of the foil and enlarge the contact area between foil and shaft. Fixation 12 of the foil in the middle is still present to avoid mutual influence. Parts can be added to shorten the length of the small pins 13. In this figure this is done by two cylinders 14 attached to the frame by plates 15 at the end of the frame.

### Example 5

### Foil Bearing with Two Foils

FIGS. 8 and 9 show a construction of a multidirectional bearing with two foils and one frame. Both foils are attached to the frame with one side on the outside and one side at the inside 16. In order to get a large area of contact between foils and shaft the foils are cutting each other as illustrated in FIG. 10.

### Example 6

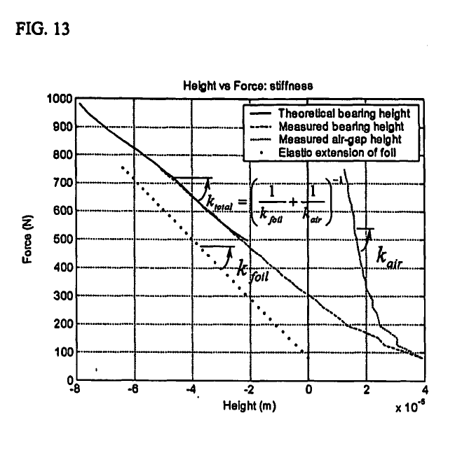

In order to verify the externally pressurised foil bearing of the present invention, a test rig was built as depicted in FIG. 12 to investigate the basic behaviour of aerostatic foils. In this set-up, the air was fed through the shaft and the foil extension as well as the gap geometry could be measured. A number of prototype bearings were tested for their load capacity, air consumption and stiffness characteristics. The load capacity and air consumption turn out to be far superior to conventional bearings. The stiffness is comparable to rigid bearings of the same dimensions. As an example, a foil bearing prototype (FIG. 11) with a 50 mm wide and 0.08 mm thick, steel foil on a 40 mm diameter shaft, (wrap angle 180 degrees) was supplied with a 6 bar air pressure. The measurements show a load capacity of more than 800 N, a radial stiffness of 8.5 N/micron, and air consumption of around 2 Nl/min. FIG. 13 illustrates the good agreement between theoretical prediction and experiment showing how the total stiffness is the resultant of the foil and air-gap stiffness, in series. Obviously, this bearing is not well optimised since the latter stiffness values are not well matched (the air gap is much stiffer than the foil). With better optimisation, a resultant stiffness of around 25 N/micron may be achievable.

### REFERENCES TO THE APPLICATION

(1) Wildman, M. “Foil Bearings”, ASME, J. Lubrication Technology, January 69, pp. 37-44.
(2) S. Gray, H. Heshmat, B. Bhushan, “Technology progress on compliant foil air bearing systems for commercial applications,” 8th Gas Bearting Symposium, Leicester Polytechnic, BHRA Fluid Engineering, 1981, paper 6, pp. 69-97.

1. A foil bearing comprising a frame and a foil, characterised in that the foil bearing has a self-aligning mechanism which allows the foil to self-adapt its position.

2. The foil bearing according to claim 1, wherein the foil is attached to the frame and extended between a first and a second attachment point.

3. The foil bearing according to claim 1, further comprising a supporting and positioning means for optimally positioning and supporting the foil, wherein the supporting and positioning means allows for a self-aligning mechanism.

4. The foil bearing according to claim 3, wherein the supporting and positioning means is cylindrical and can rotate around two axes normal to its geometrical axis.

5. The foil bearing according to claim 3, wherein the supporting and positioning means comprises two cylinders attached to the frame and which can rotate around two axes normal to their geometrical axes.

6. The foil bearing according to claim 4, wherein the cylindrical supporting and positioning means are attached to the frame through small pins forming point contacts in blind holes drilled in the cylindrical supporting and positioning means.

7. The foil bearing according to claim 3, wherein the supporting and positioning means comprises a spring.

8. The foil bearing according to claim 1, wherein the foil bearing is externally pressurised.

9. The foil bearing according to claim 8, wherein the external pressurisation is obtained through fluid supplied via the shaft.

10. The foil bearing according to claim 8, wherein the external pressurisation is obtained through fluid supplied via the foil.

11. The foil bearing according to claim 8, wherein the external pressurisation is obtained through one or multiple flexible fluid supplies.

12. The foil bearing according to claim 11, wherein said flexible fluid supply is a rubber or a plastic hose.

13. The foil bearing according to claim 9, wherein the fluid is gas, more in particular air.

14. The foil bearing according to claim 3, wherein the foil is additionally fixed to the middle of the frame.

15. The foil bearing according to claim 14, comprising two additional cylindrical supporting and positioning means allowing for the self-alignment of the foil and thereby supporting and positioning the foil on a different position than the other supporting and positioning means.

16. The foil bearing according to claim 1, comprising a second foil, attached to the frame at two attachment points.

17. The foil bearing according to claim 16, wherein the two foils are interwoven.

18. The foil bearing according to claim 1, wherein said foil has stiffening ribs or any other texture or cross-sectional profile, to enhance stiffness and/or damping.

19. The foil bearing according to claim 1, wherein said foil is supported by electromagnetic, magnetostrictive, piezoelectric or any suitable type of actuator, so that the foil could be moved statically or dynamically during operation, whereby its characteristics could be controlled.

20. The foil bearing according to claim 1, wherein said foil is made of metal.

21. The foil bearing according to claim 1, wherein said foil is made from a “smart” material, e.g. PVD or piezoelectric material, so that the characteristic of the foil could be changed during operation, by controlling an electric current that is fed to the foil.

22. The foil bearing according to claim 10, wherein the fluid is gas, more in particular air.

23. The foil bearing according to claim 1, wherein the foil is additionally fixed to the middle of the frame.
